(19) United States
(12) Patent Application Publication
(10) Pub. No.: US 2008/0291695 A1
(43) Pub. Date: Nov. 27, 2008

(54) Display Device

(76) Inventors: Yutaka Okayasu, Kyoto (JP); Shogo Nagasaka, Shiga-ken (JP); Shinya Sonoda, Kyoto (JP); Tsuyoshi Kubota, Aichi (JP)

Correspondence Address: OSHA LIANG L.L.P., 1221 MCKINNEY STREET, SUITE 2800, HOUSTON, TX, 77010, US

(21) Appl. No.: 11/629,249

(22) PCT Filed: Jun. 14, 2005
(86) PCT No.: PCT/JP2005/010872

§ 371 Date: Dec. 11, 2006

(30) Foreign Application Priority Data
Jun. 15, 2004 (JP) 2004-177208

(51) Int. Cl. G09F 13/12; F21V 8/00

(52) U.S. Cl. 362/619; 40/442

(57) ABSTRACT

The present invention is to provide a display device capable of displaying a prescribed display pattern by making the pattern luminous as needed, while the rear side can usually be seen through easily. In order to achieve it, a display pattern 20 is formed with minute recesses 29 provided on at least one surface of a translucent substrate 10, and at least one light source 30 is disposed on a side end face of the translucent substrate 10. The area density of the minute recesses 29 constituting the display pattern 20 is set to not more than 20%, and the opening area of one recess 29 is set to not more than 0.03 mm².

### TECHNICAL FIELD

The present invention relates to a display device, in particular, to a display device which is transparent usually but capable of displaying display patterns such as dots, lines, characters, numbers and pictures by making them luminous as needed.

### BACKGROUND ART

Conventionally, as a display device, there is one including: a variable symbol display device capable of displaying a plurality of symbols variably; a light guide plate having translucency disposed in front of the variable symbol display device; and a light source for introducing light to the inner side of the light guide plate from an end face, for example. The light of the light source is introduced from the end face of the light guide plate to the inner side, and is diffused and reflected by the light emitting unit formed on the surface of the light guide plate to thereby perform display (see Patent Document 1).

### Patent Document 1: Japanese Patent Laid-Open Publication No. 11-137774

### DISCLOSURE OF THE INVENTION

### Problem to be Solved by the Invention

However, in the display device described above, the light emitting unit is conspicuous, and desired transparency is hardly obtained, so there is a problem that the rear side thereof is hardly seen through the light guide plate.

In view of the above-mentioned problem, it is an object of the present invention to provide a display device capable of displaying prescribed display patterns by making them luminous as needed while the rear side thereof can usually be seen through easily.

### Means for Solving the Problem

In order to solve the above-described problem, a display device according to the present invention is a display device in which a display pattern is formed with minute recesses provided on at least one surface of a translucent substrate, and at least one light source is disposed on a side end face of the translucent substrate so as to introduce light to the display pattern. The display device is so configured that the area density of the minute recesses forming the display pattern is not more than 20%, and an opening area of a recess is not more than 0.03 mm². Note that a minute recess means a shape formed for expressing a display pattern by making it luminous here, not including a fine shape for solely preventing reflection. Of course, minute recesses for a display pattern and a fine shape for preventing reflection may be used together.

According to the present invention, minute recesses forming a display pattern are set to have size and area density which are invisible with eyes. Therefore, when the light source is not turned on, the display pattern is not obtrusive but transparent, so the rear side can be seen through easily. Then, by turning on the light source as needed to thereby cause the light to be reflected at the recesses, a prescribed display pattern can be displayed.

As an embodiment according to the present invention, the recess may be in a hemispherical shape.

According to the present embodiment, since the recess is in a hemispherical shape, there is no directionality, no variation is caused in reflection efficiency, and uniform brightness can be secured easily.

As another embodiment according to the present invention, the device may be so configured that the area density of the recesses or the opening area of the recess increases as separating from the light source.

According to the present embodiment, a display pattern having even brightness can be obtained.

Further, as another embodiment according to the present invention, a cylindrical lens or a collimate lens may be disposed between a side end face of the translucent substrate and the light source.

According to the present embodiment, it is possible to boost the light incident efficiency and to display a display pattern with uniform brightness.

As a new embodiment according to the present invention, a plurality of translucent substrates may be overlaid such that the area density of the recesses becomes not more than 20%, or the area density of the recesses in the display pattern may be made to be non-uniform so as to express gradation.

According to the present embodiment, expressions in various kinds and ways become possible, which brings an effect of wide variety of uses.

### BRIEF DESCRIPTION OF THE DRAWINGS

FIGS. 1A, 1B and 1C are front views showing a first embodiment of a display device according to the present invention and applications thereof, respectively.

FIG. 2A is a front view showing a second embodiment of the display device according to the present invention, and FIGS. 2B and 2C are front views showing before and after lighting of a third embodiment, respectively.

FIGS. 3A and 3B are front views showing fourth and fifth embodiments of the display device according to the present invention.

FIG. 4 is a perspective view showing a sixth embodiment of the display device according to the present invention.

FIG. 5A is a main part enlarged perspective view showing a more specific example of use according to the present invention, and FIGS. 5B and 5C are perspective views showing before and after lighting, respectively.

FIGS. 6A and 6B are exploded perspective view and a perspective view showing more specific another example of use of the display device according to the present invention.

FIGS. 7A, 7B and 7C are a perspective view, a partial enlarged view and a cross-sectional view showing an example according to the present invention.

### DESCRIPTION OF REFERENCE NUMERALS

10 translucent substrate
11, 12, 13 translucent substrate
14, 15, 16 translucent substrate
20, 21, 22 display pattern
23a, 23b, 23c display pattern
24a, 24b, 24c display pattern
25 display pattern
29 recess
30 light source
31, 32, 33 light source
34, 35, 36 light source
40 lens
41 product case
42 display product

### BEST MODE FOR CARRYING OUT THE INVENTION

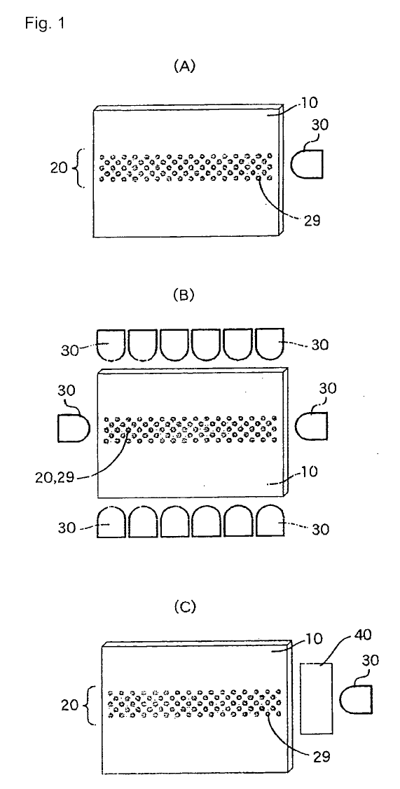

Embodiments of a display device according to the present invention will be described in accordance with the accompanying drawings of FIGS. 1 to 6. However, invisible minute recesses constituting a display pattern are shown by being deformed for convenience of description.

As shown in FIG. 1A, a first embodiment is a case in which minute recesses 29 are arranged in a houndstooth pattern with prescribed pitches on one side face of a translucent substrate 10 so as to form a display pattern 20. On a side end face of the translucent substrate 10, a light source 30 for introducing light to the display pattern 20 is disposed.

As a material of the translucent substrate 10, polycarbonate resin, acrylic resin, glass or the like may be used for example. Anything enabling to form transparent minute recesses 29 is acceptable.

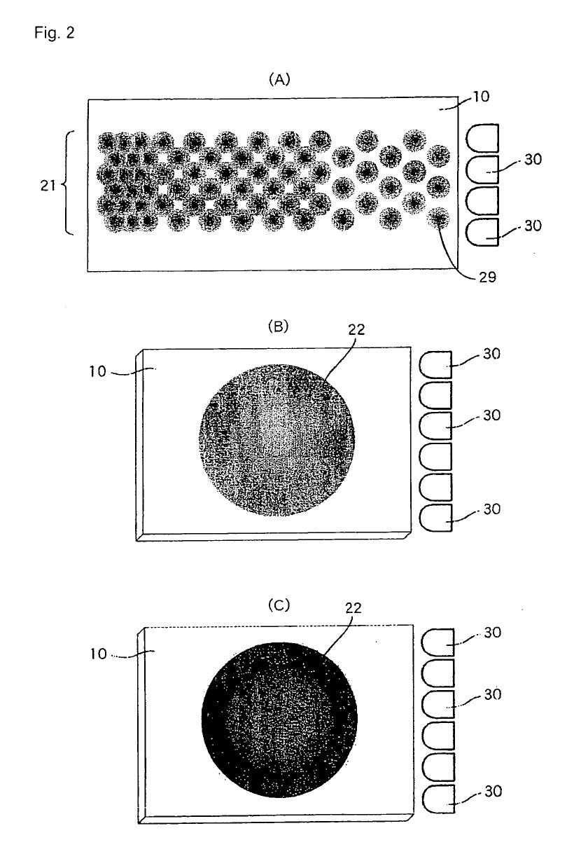

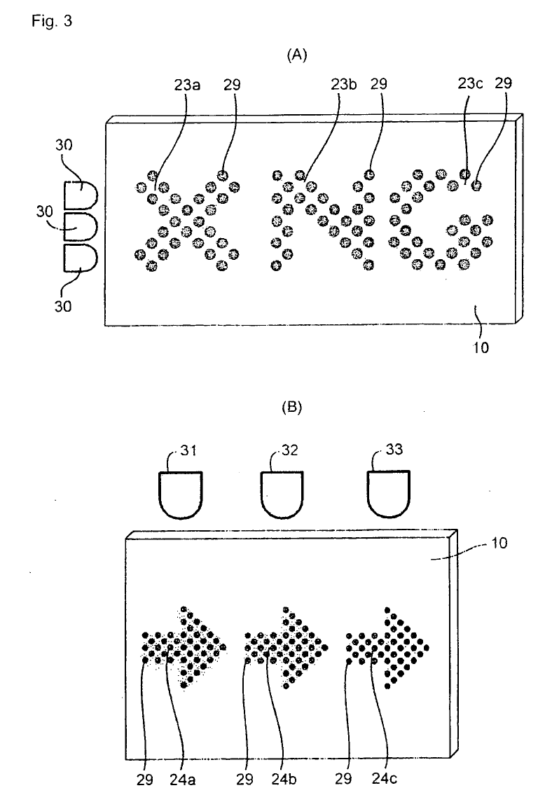

The display pattern 20 is not limited to one in which the recesses 29 are uniformly arranged in a band shape, but it may express gradation by changing the area density of the recesses 29 gradually, like a second embodiment shown in FIG. 2A. Further, in the case of displaying a circular display pattern 22 with recesses like a third embodiment shown in FIGS. 2B and 2C, it may be so adapted that by gradually increasing the area density of recesses from the outer peripheral part to the center, the brightness changes gradually such that the center part of the display pattern becomes the brightest. Further, like fourth and fifth embodiments shown in FIGS. 3A and 3B respectively, characters may form display patterns 23a, 23b and 23c, or picture patterns of arrows may form display patterns 24a, 24b and 24c with the recesses 29.

The recess 29 is not limited to a hemispherical recess, but may be in a triangular pyramid shape, a square pyramid shape, or a conical shape. The opening area of the recess 29 is preferably not more than 0.03 mm². If the opening area exceeds 0.03 mm², it becomes visible easily, so it is obtrusive. Therefore, if the recess 20 is a hemispherical dimple, the diameter is preferably not more than 200 μm, and more preferably, not more than 100 μm.

Further, the area density of the recesses 29 is preferably not more than 20%, and more preferably, not more than 10%. If the area density of the recesses 29 exceeds 20%, it is difficult to secure desired transparency. Note that the area density of the recesses 29 means the total opening area of all recesses 20 in a unit area.

Further, a pitch between the recesses 29 is preferably not less than 200 μm. If the pitch is less than 200 μm, it is difficult to secure desired transparency.

As the light source 30, an LED or a xenon lamp may be used for example. It is only necessary to have at least one light source 30. For example, a plurality of light sources may be arranged in alignment, or they may be arranged on the whole periphery of the translucent substrate 10 like a deformation of the first embodiment as shown in FIG. 1B. Further, all of the light sources 30 are not necessarily in the same color. Like a fifth embodiment shown in FIG. 3B, light sources 31, 32 and 33 of different colors may be arranged in alignment. By sequentially turning on and off the light sources 31, 32 and 33 arranged in alignment, it is possible to display state changes in which arrow display patterns 24a, 24b and 24c move with the color being changed.

Further, in order to converge and disperse light efficiently so as to increase the brightness and also make the brightness uniform, a collimate lens, a cylindrical lens 40 may be disposed between the translucent substrate and the light source 30, like another application of the first embodiment shown in FIG. 1C, for example. Further, in order to make the brightness uniform, it is acceptable to arrange light sources on the opposite both end faces of the translucent substrate 10, to provide a plurality of light sources in alignment, or to increase the area density or opening areas of recesses positioned distant from a light source so as to boost light reflectance, not limited to the method mentioned above. Note that multiple means described above can be combined, of course.

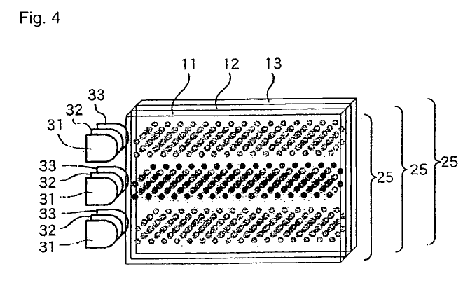

Further, the number of translucent substrates having the display pattern 20 is not necessarily one. Like a sixth embodiment shown in FIG. 4, a plurality of translucent substrates 11, 12 and 13, having display patterns 25, may be used by being overlaid. In such a case, the colors of the light sources 31, 32 and 33 may be different in respective translucent substrates 11, 12 and 13. With the colors of the light sources 31, 32 and 33 being different in this way, there is an advantage of enabling three-dimensional animation rendering by lighting the red light source 31 and the blue light source 32 simultaneously so as to express the display pattern in purple.

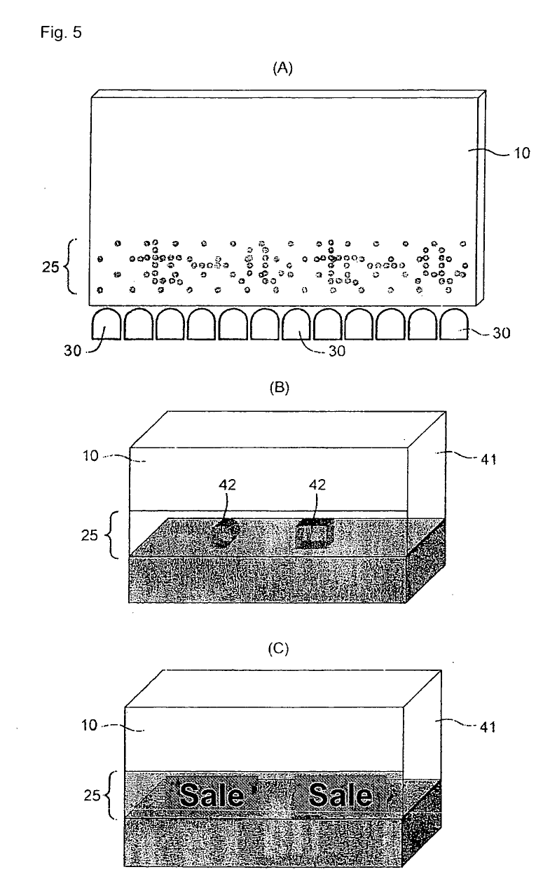

As a more specific example of use of the display device according to the above-described embodiment, there is a case where it is used as a part of a product case 41 for example, as shown in FIG. 5.

That is, in a display pattern 25 provided on the lower edge part of the translucent substrate 10, minute recesses are arranged in a band shape with low density, and also characters of “sale” are drawn with minute recesses arranged with high density in the band area (FIG. 5A). Then, a plurality of light sources 30 are arranged in alignment on the lower edge part of the translucent substrate 10 so as to form the front face part of the product case 41 (FIG. 5B).

Generally, the translucent substrate 10 is transparent, so a displayed product 42 in the product case 41 is directly visible through the translucent substrate 41. In the case where a customer comes close to the product case 41, when the light source 30 is blinked via a sensor not shown, the display in which bright characters of “sale” come up in the display pattern of a half-light band shape and then go out, is repeated. The characters of “sale” are suddenly displayed brightly in a seemingly transparent area, so it is unpredictable, which can give a strong visual impression to the customer.

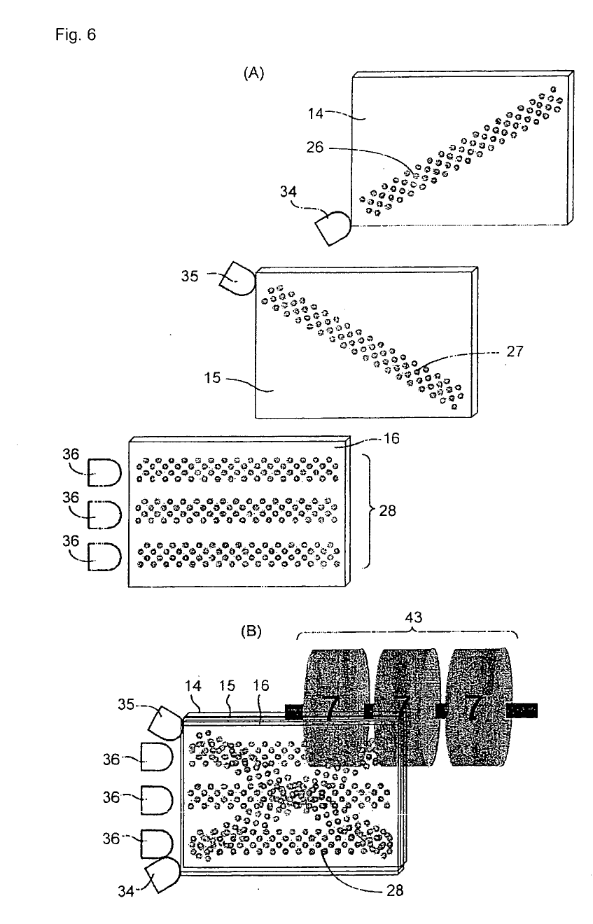

As another method of using, there is a case where three overlaid translucent substrates 14, 15 and 16 are arranged on the front face of a variable display unit 43 of a slot machine for example, as shown in FIG. 6. The translucent substrates 14, 15 and 15 have different display patterns 26, 27 and 28 formed in a band shape, respectively (FIG. 5A). When a full deck of reel pictures are shown on the variable display unit 43, the display pattern in a band shape linking the reel pictures may be made luminous so as to enhance the rendering. In particular, various kinds and ways of expressions can be possible by introducing light from the light sources 34, 35 and 36 of different colors so as to display the degree of winning.

### EXAMPLE

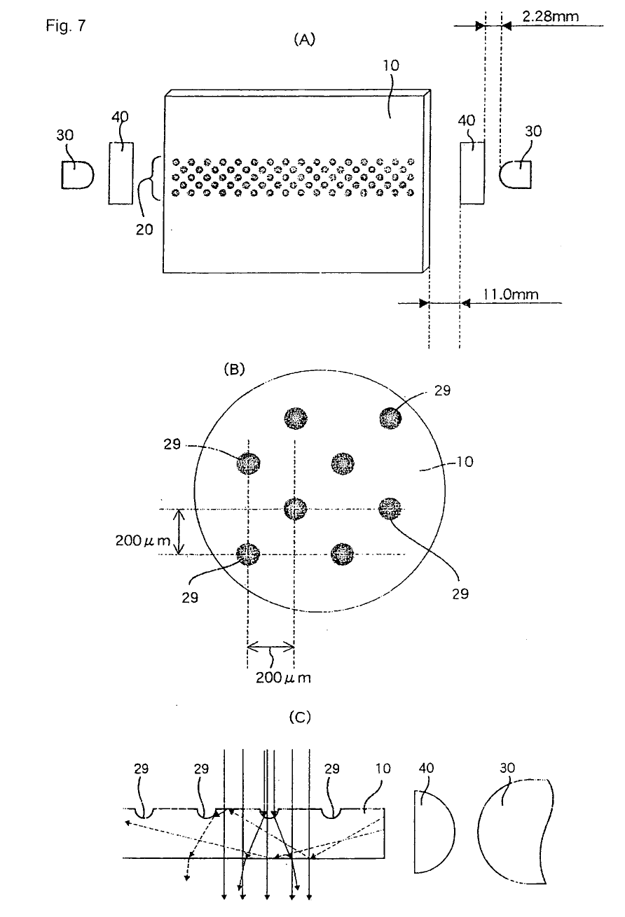

As shown in FIG. 7, on one side face of a transparent polycarbonate resin plate of 100 mm wide, 150 mm long and 2 mm thick, dimples 29 which were minute hemispherical recesses having a diameter of 100 μm were formed in a houndstooth pattern at a ratio of 200 μm pitch, whereby the translucent substrate 10 having the display pattern 20 of 10% dimple area density was obtained. Then, on the both-side end faces of the translucent substrate 10, two PMMA cylindrical lenses 40 having a focus diameter of 10.6 mm, and two red LED 30 (product name: LUR3333H (made by LIGHTEK)) having a diameter of 5.9 mm and brightness of 7700 mcd (typ.) were arranged, respectively (FIG. 7A).

Then, when observing the translucent substrate 10 with eyes without lighting the LED, presence of the dimples was not obtrusive at all, so the rear side could been seen sufficiently. Further, when observing it with the LED being lighted, a display pattern of a band shape could be seen clearly on the surface of the transparent translucent substrate.

### INDUSTRIAL APPLICABILITY

The display device according to the present invention can be applied not only as an electric decoration of game equipment but also to a product case, a direction board, an advertising display light, a warning light, interior goods, and the like.

1. A display device in which a display pattern is formed with minute recesses provided at least one surface of a translucent substrate, and at least one light source is arranged on a side end face of the translucent substrate so as to introduce light to the display pattern, wherein
an area density of the minute recesses forming the display pattern is not more than 20%, and an opening area of one recess is not more than 0.03 mm².

2. The display device according to claim 1, wherein the recess is in a hemispherical shape.

3. The display device according to claim 1, wherein the area density of the recesses becomes higher as separating from the light source.

4. The display device according to claim 1, wherein the opening area of the recess increases as separating from the light source.

5. The display device according to claim 1, wherein a cylindrical lens is disposed between a side end face of the translucent substrate and the light source.

6. The display device according to claim 1, wherein a collimate lens is disposed between a side end face of the translucent substrate and the light source.

7. The display device according to claim 1, wherein a plurality of translucent substrates are overlaid such that the area density of the recesses becomes not more than 20%.

8. The display device according to claim 1, wherein the area density of the recesses in the display pattern is made to be non-uniform to thereby express gradation.

9. The display device according to claim 2, wherein the area density of the recesses becomes higher as separating from the light source.

10. The display device according to claim 2, wherein the opening area of the recess increases as separating from the light source.

11. The display device according to claim 3, wherein the opening area of the recess increases as separating from the light source.

12. The display device according to claim 2, wherein a cylindrical lens is disposed between a side end face of the translucent substrate and the light source.

13. The display device according to claim 3, wherein a cylindrical lens is disposed between a side end face of the translucent substrate and the light source.

14. The display device according to claim 4, wherein a cylindrical lens is disposed between a side end face of the translucent substrate and the light source.

15. The display device according to claim 2, wherein a collimate lens is disposed between a side end face of the translucent substrate and the light source.

16. The display device according to claim 3, wherein a collimate lens is disposed between a side end face of the translucent substrate and the light source.

17. The display device according to claim 4, wherein a collimate lens is disposed between a side end face of the translucent substrate and the light source.

18. The display device according to claim 5, wherein a collimate lens is disposed between a side end face of the translucent substrate and the light source.
